(19) United States
(12) Patent Application Publication
(10) Pub. No.: US 2010/0314526 A1
(43) Pub. Date: Dec. 16, 2010

(54) PANEL SPACER

(76) Inventor: JERRY B. LARSON, Gilbert, AZ (US)

Correspondence Address: WALTER L. BEAVERS, 326 SOUTH EUGENE STREET, GREENSBORO, NC, 27401, US

(21) Appl. No.: 12/484,414

(22) Filed: Jun. 15, 2009

(51) Int. Cl. F16M 13/00

(52) U.S. Cl. 248/634

(57) ABSTRACT

A panel spacer presents a somewhat spherical body with pyramidal indents in the upper and lower hemispheres separated by a relatively wide equator. The spacers are formed from a conventional resilient polymeric material with the indents providing easy handling and preventing rolling of the spacers when in place for example in a rail groove. In an alternate embodiment of the panel spacers the hemispheres are rotated approximately 27½° along the spacer axis.

### FIELD OF THE INVENTION

The invention herein pertains to panel spacers as are used in joints for cabinet doors and panels. The spacers are somewhat spherical in shape and include indents for ease in gripping and positioning within the joints.

### DESCRIPTION OF THE PRIOR ART AND OBJECTIVES OF THE INVENTION

Panel spacers have long been used in wooden cabinet door tongue and groove and other joints. These spacers provide resiliency for the joints to prevent cracking as wood expands and contracts in changing environmental conditions. Various shaped spacers have been used in the past as seen in U.S. Pat. Nos. Des. 406,226, Des. 447,930, 5,317,853 and 5,367,851. Certain prior spacers have been formed of non-durable materials and have lost their resiliency after limited use. Other panel spacers have the durability required but are difficult to insert and properly maintain in place in joints during assembly. Other prior spacers are expensive and impractical for economical door or cabinet manufacturing purposes.

Thus with the problems and disadvantages associated with prior joint spacers, the present invention was conceived and one of its objectives is to provide a relatively low cost panel spacer which can be used in various styles and grades of panels and cabinets.

It is another objective of the present invention to provide a panel spacer with a somewhat spherical shape but which has the advantages of easy handling and positioning during panel assembly due in part to its outer surface irregularity.

It is still another objective of the present invention to provide a panel spacer which retains its resiliency over extended periods of time and is economically feasible to manufacture and sell.

It is yet another objective of the present invention to provide a panel spacer which includes a series of indents to improve its handling quality and to reduce its weight.

Various other objectives and advantages of the present invention will become apparent to those skilled in the art as a more detailed description is set forth below.

### SUMMARY OF THE INVENTION

The aforesaid and other objectives are realized by providing a panel spacer which is somewhat spherical in shape and includes a plurality of pyramidal indents to assist in use. The indents reduce the weight and cost of the materials employed in forming the spacers and help in preventing inadvertent movement once the spacers are in place in a panel slot or joint due to the irregular outer surface of the spacer. The panel spacers are formed from a polymeric material having a desired resiliency and durability. The indents create an irregular outer surface of the spacer which allows the spacer to be easily, manually handled and placed in a desired location of a panel rail slot.

### BRIEF DESCRIPTION OF THE DRAWINGS

FIG. 1 illustrates a perspective view of a first embodiment of the invention;

FIG. 2 depicts a top plan view of the panel spacer as shown in FIG. 1, it being understood that the bottom plan view is a mirror image thereof;

FIG. 3 shows a side elevational view of the panel spacer as shown in FIG. 1, it being understood that all side views being the same due to the symmetry of the panel spacer;

FIG. 4 features a perspective view of a second or alternate embodiment of the invention;

FIG. 5 demonstrates a top plan view of the spacer shown in FIG. 4, it being understood that the bottom plan view is a mirror image thereof rotated 27½°;

FIG. 6 pictures a side elevational view of the panel spacer as shown in FIG. 4, it being understood that all side views are the same due to the symmetry of the panel spacer;

FIG. 7 schematically shows a typical cabinet door having a panel and rail prior to assembly with the panel spacers exploded therefrom; and

FIG. 8 schematically illustrates the panel and rail in FIG. 7 in assembled fashion with the panel spacers therein seen in dashed lines.

### DETAILED DESCRIPTION OF THE PREFERRED EMBODIMENT AND OPERATION OF THE INVENTION

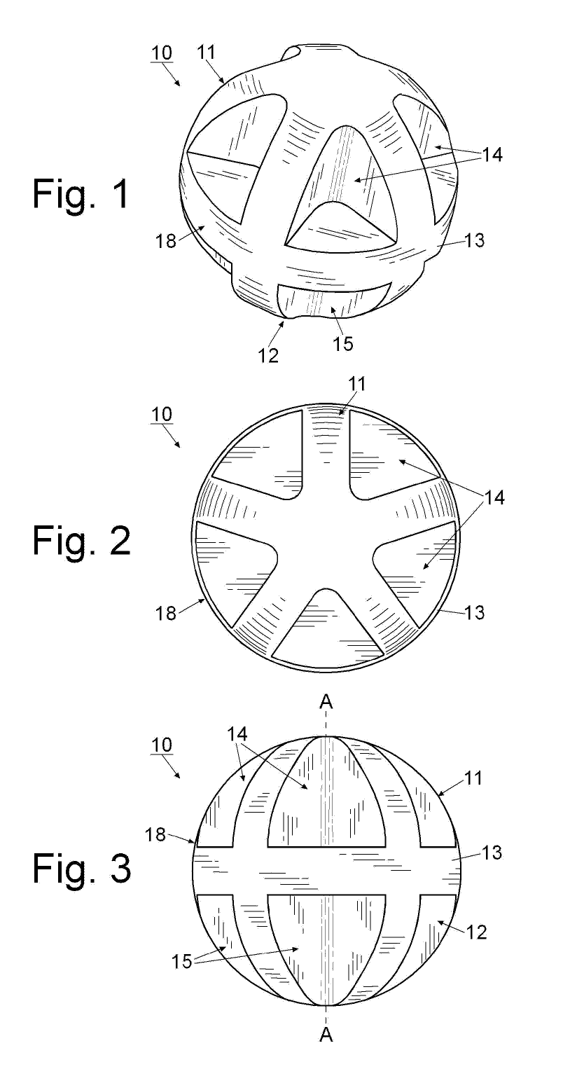

For a better understanding of the invention and its operation, turning now to the drawings, FIG. 1 shows preferred panel spacer 10 having spherical body 18 with a first or upper hemisphere 11 and a second or lower hemisphere 12 as also seen in FIG. 3. First hemisphere 11 and second hemisphere 12 are identical in size and shape and are separated by relatively thick equator 13. First hemisphere 11 includes five (5) indents 14 equally spaced around equator 13 whereas second hemisphere 12 includes five (5) indents 15 equally spaced around equator 13. Axis A-A of spacer 10 is shown in FIG. 3 with indents 14, 15 aligned along axis A-A.

Also shown in FIGS. 1, 2 and 3, panel spacer 10 comprises a somewhat spherical body 18 preferably formed from a non-oil bleeding thermoplastic elastomer of GLS Corporation of McHenry, Ill., 60050. This is a thermoplastic elastomer having a Durometer Hardness (Shore A, 10 sec.) of about 70, a tensile strength in the range of 425-430 psi and an elongation breakage factor of about 530-683% identified as product: LC345-130 under the trademark “Polyone” GLS 345-130 Beige as further detailed in the product specification sheets of GLS Corporation, incorporated by reference herein. This thermoplastic elastomer is environmentally friendly as no phthalates are used in its manufacture and it is formed of a hard (higher Durometer) elastomer than commercial spacers while maintaining desired compressibility characteristics due to its design having indents 14, 15 therein. Alternately, other suitable thermoplastic elastomers meeting the required criteria may also be used. Spacers 10 are formed by conventional injection molding techniques.

Panel spacer 10 has a preferred size of 6.35 mm (0.25 in.) in diameter although the size varies dependent on the particular panel tongue and groove dimensions with which panel spacer 10 is employed.

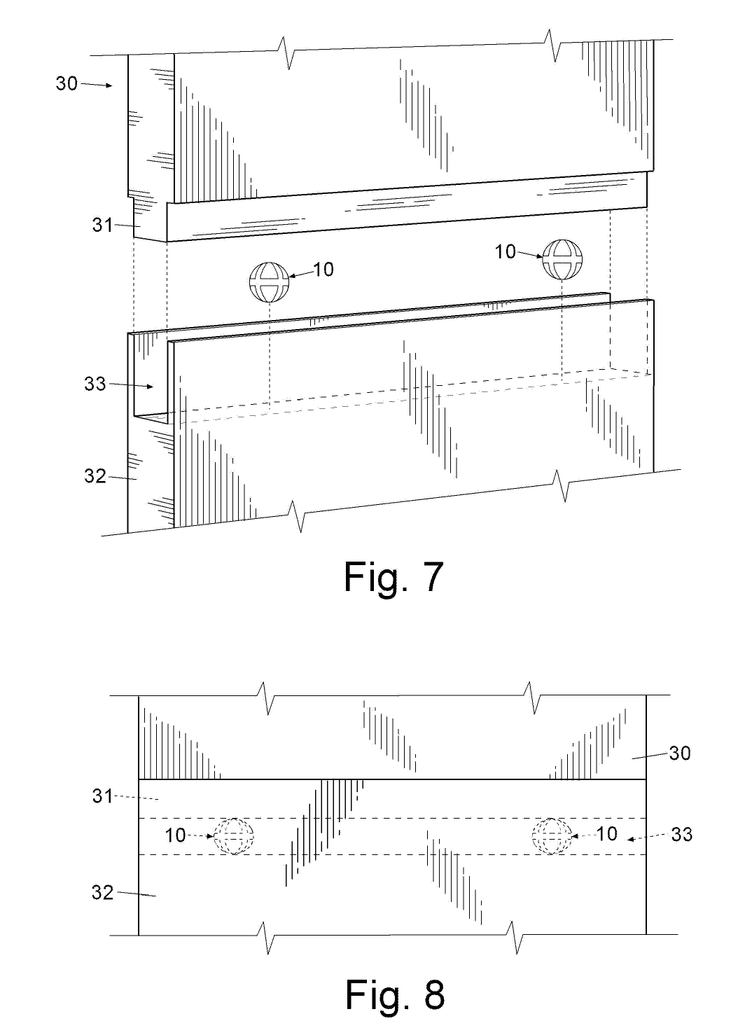

Indents 14, 15 are helpful in handling spacer 10 and prevent unwanted movement of spacer 10 once positioned in a rail groove. For example, as shown in FIGS. 7 and 8, panel spacers 10 are positioned between upper wooden panel 30 having tongue 31 and lower wooden rail 32 having groove 33 which may be for example, a kitchen cabinet door panel joint. Conventional spacers (not shown)which may have a smooth outer surface would tend to shift when initially positioned within rail 32 especially if tilted, before panel 30 is inserted. However, panel spacers 10 with indents 14, 15 as shown in FIGS. 1 and 2 prevent this inadvertent rolling or shifting due to the irregular outer surface. Additionally, indents 14, 15 allow easier manual handling of spacers 10 since indents 14, 15 provide for a better finger grip. Axial alignment of indents 14, 15 is shown in FIG. 2. In FIG. 8 panel spacers 10 are shown in a somewhat distorted position with panel 30 and rail 32 expanded for example, due to heat and humidity.

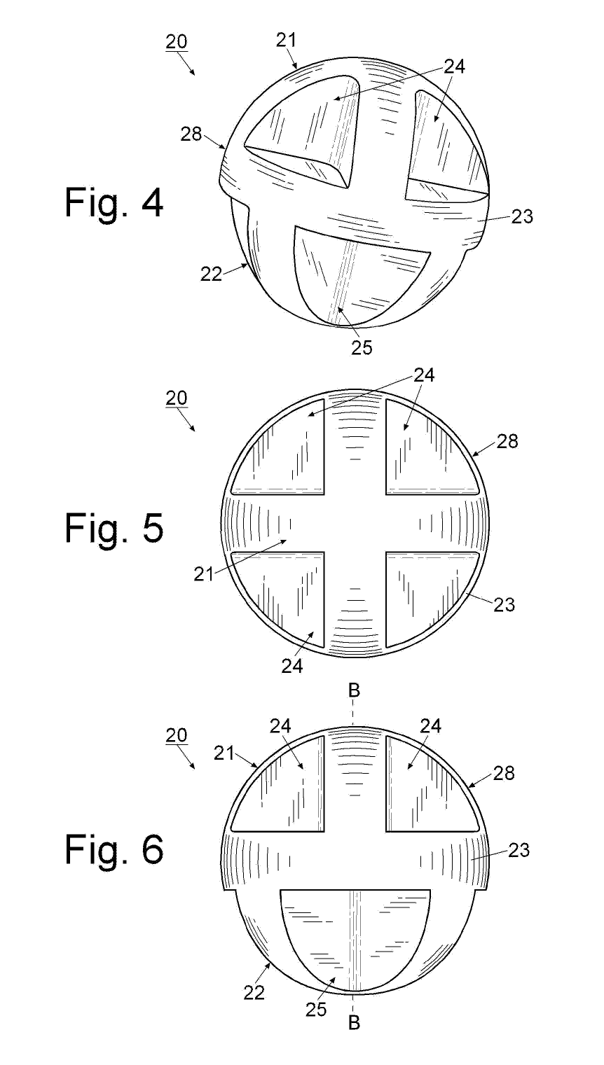

An alternate embodiment of the invention is shown in FIGS. 4, 5 and 6 with panel spacer 20. Panel spacer 20 has spherical body 28 and is formed of the same material as panel spacer 10 by injection molding and includes an upper or first hemisphere 21 and a lower or second hemisphere 22. As seen in FIG. 6, equator 23 divides body 28 into first hemisphere 21 and second hemisphere 22. Hemispheres 21 and 22 are identical but are rotated approximately 27½° along axis B-B as seen in FIG. 6. Further, hemispheres 21 and 22 contain only four (4) indents 24, 25 respectively as opposed to the five (5) indents 14, 15 as shown in panel spacer 10 in FIGS. 1, 2 and 3. Indents 24 and 25 are also pyramidal and provide the same advantages as indents 14, 15 as described above but are larger in size for spacers of the same outer dimensions.

The illustrations and examples provided herein are for explanatory purposes and are not intended to limit the scope of the appended claims.

I claim:

1. A panel spacer comprising: a resilient spherical body, said body defining an equator, a plurality of indents, said indents positioned on each side of said equator.

2. The panel spacer of claim 1 wherein said equator divides said body into equal hemispheres.

3. The panel spacer of claim 1 wherein said indents are pyramidal.

4. The panel spacer of claim 2 wherein each of said hemispheres defines four indents.

5. The panel spacer of claim 2 wherein each of said hemispheres defines five indents.

6. The panel spacer of claim 2 wherein one of said hemispheres is rotated along the axis of the body about 27½°.

7. The panel spacer of claim 1 formed from a resilient polymeric material.

8. The panel spacer of claim 1 having an overall diameter of approximately 6.35 mm.

9. A spacer for positioning in a cabinet door joint comprising: a spherical body, said body formed form a resilient polymeric material, said body defining an equator, said equator separating said body into two hemispheres, each of said hemispheres defining an indent.

10. The spacer of claim 9 wherein said hemispheres are equally sized.

11. The spacer of claim 9 wherein each of said hemispheres define a plurality of indents.

12. The spacer of claim 9 wherein each of said indents is pyramidal.

13. The spacer of claim 9 wherein said hemispheres are rotated about 27½° to one another along the axis of said body.

14. The spacer of claim 11 wherein each of said hemispheres defines four pyramidal indents.

15. A panel joint comprising a tongue, a rail, said rail defining a groove, a spacer, said spacer positioned in said groove, said spacer comprising a spherical body, said body formed from a resilient polymeric material, said body defining an equator, said equator separating said body into two hemispheres, and each of said hemispheres defining an indent.

16. The panel joint of claim 15 wherein said indents are pyramidal.
